(19) United States
(12) Patent Application Publication
(10) Pub. No.: US 2026/0303976 A1
(43) Pub. Date: Oct. 1, 2026

(54) IMAGING DEVICE AND METHOD FOR CONTROLLING IMAGING DEVICE

(71) Applicant: CANON KABUSHIKI KAISHA, Tokyo (JP)

(72) Inventor: RYUKI HASHIDA, Kanagawa (JP)

(21) Appl. No.: 19/543,049

(22) Filed: Feb. 18, 2026

(30) Foreign Application Priority Data
Mar. 26, 2025 (JP) 2025-051912

(51) Int. Cl. H04N 23/698; G06T 3/4038

(52) U.S. Cl. CPC H04N 23/698; G06T 3/4038

(57) ABSTRACT

An imaging device includes: a processor; and a memory storing a program which, when executed by the processor, causes the imaging device to: execute imaging processing of capturing, simultaneously with a first image, a second image having a view angle wider than a view angle of the first image; execute generation processing of generating a composite image in which areas of the second image excluding an area corresponding to the first image are composited around the first image; and execute adding processing of adding, to the composite image, history information indicating that the composite image has not been edited.

### BACKGROUND

### Field of the Technology

The present disclosure relates to an imaging device and a method for controlling the imaging device.

### Description of the Related Art

In recent years, C2PA, a technical standardization organization, has developed technical specifications that ensure a source and reliability of content, with the aim of enabling publishers, creators, and consumers to track a source of media. Based on the C2PA standard, image data generated at the time of photographing and editing includes data called Manifest that stores Actor (camera name, software name, etc.), Hash, a claim signature (digital signature), a thumbnail image, and the like. It is possible to determine whether the image is “original” or “edited” by referring to Manifest.

However, in a case where a user who is a provider of content performs minor editing of an image, there is a case where the user wants to indicate that the image after editing has not been edited but is the original. For example, in a case where the same object is photographed with a multi-view camera at the same timing, a composite image obtained by compositing a plurality of images after photographing is desirably treated as an original image because no mismatch occurs with respect to the object.

Japanese Patent Laid-Open No. 2024-076326 discloses a technique for determining authenticity of content edited from the time of generation. In Japanese Patent Laid-Open No. 2024-076326, it is not assumed that a composite image obtained by compositing a plurality of images photographed at the same timing by a multi-view camera is treated as an original image that is not edited even when authenticity of the composite image can be proved as edited content.

### SUMMARY

The present disclosure provides an imaging device capable of treating a composite image obtained by compositing a plurality of simultaneously captured images as an unedited image.

An imaging device according to the present disclosure includes: a processor; and a memory storing a program which, when executed by the processor, causes the imaging device to: execute imaging processing of capturing, simultaneously with a first image, a second image having a view angle wider than a view angle of the first image; execute generation processing of generating a composite image in which areas of the second image excluding an area corresponding to the first image are composited around the first image; and execute adding processing of adding, to the composite image, history information indicating that the composite image has not been edited.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of an imaging device.

FIG. 2 is a diagram for explaining generation of a composite image.

FIGS. 3A and 3B are diagrams illustrating an outline of recorded contents of an image file.

FIG. 4 is a flowchart illustrating history information adding processing at the time of imaging.

FIG. 5 is a flowchart illustrating history information adding processing at the time of editing.

### DESCRIPTION OF THE EMBODIMENTS

Hereinafter, an embodiment of the present disclosure is described with reference to the drawings. Note that the present disclosure is not limited to the following embodiment. All of a plurality of features described in the embodiment are not necessarily required, and may be arbitrarily combined.

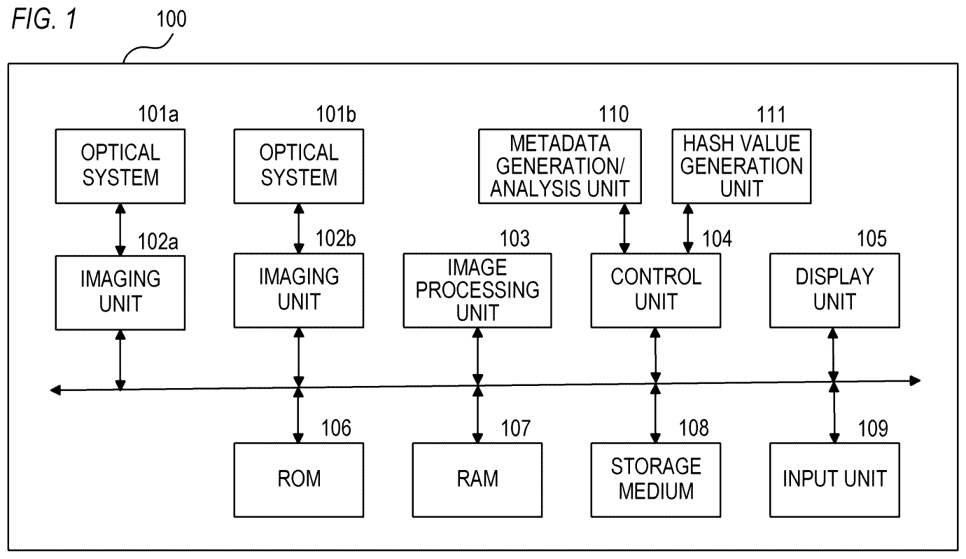

FIG. 1 is a diagram illustrating a configuration of an imaging device 100. The imaging device 100 according to the present disclosure only needs to be a device capable of capturing a plurality of images having different view angles at the same timing, and may be an electronic apparatus such as a smartphone or a tablet.

The imaging device 100 includes an optical system 101a, an optical system 101b, an imaging unit 102a, and an imaging unit 102b. The imaging unit 102a and the imaging unit 102b correspond to the optical system 101a and the optical system 101b, respectively. The optical system 101a and the optical system 101b are also collectively referred to as an optical system 101. The imaging unit 102a and the imaging unit 102b are also collectively referred to as an imaging unit 102. Furthermore, the imaging device 100 includes an image processing unit 103, a control unit 104, a display unit 105, a read only memory (ROM) 106, a random access memory (RAM) 107, a recording medium 108, and an input unit 109. The imaging device 100 further includes a metadata generation/analysis unit 110 and a hash value generation unit 111.

The imaging device 100 has two or more optical systems 101, and can simultaneously capture two images using the two imaging units 102. Although the optical systems 101 are arranged so as to photograph in the same direction, the optical systems 101 have view angles different from each other. The imaging device 100 can simultaneously capture images having different view angles. For example, using the imaging unit 102b, the imaging device 100 can capture an image having a view angle wider than that of an image captured using the imaging unit 102a. Note that the imaging device 100 may include three or more imaging units 102. In this case, the imaging device 100 can simultaneously capture three or more images having different view angles.

The imaging unit 102 is, for example, an imaging element such as a CCD or a CMOS image sensor. The imaging unit 102 photoelectrically converts optical images having different view angle ranges and individually formed by the plurality of optical systems 101, and outputs the converted images as imaging signals to the image processing unit 103. The imaging unit 102 and the other components are connected by a bus. Furthermore, in a case where the imaging unit 102 is configured separately from the other components, the imaging unit 102 may be connected to the other components by wire or wirelessly.

The image processing unit 103 performs processing such as noise removal and amplification on the imaging signal acquired from the imaging unit 102 by analog front end (AFE), and converts the imaging signal into a digital signal. The image processing unit 103 generates image data from the converted digital signal and performs various types of image processing on the generated image data. The image processing unit 103 records the processed image data in the RAM 107. The image processing unit 103 can composite images of different view angles captured by the plurality of imaging units 102.

The control unit 104 is, for example, a central processing unit (CPU). The control unit 104 reads a control program (also referred to as an operation program) from the ROM 106, develops the read control program into the RAM 107, and executes the control program. As a result, the control unit 104 controls each functional unit of the imaging device 100 to control the entire imaging device 100.

The display unit 105 is, for example, a liquid crystal display panel. The display unit 105 displays a captured image based on the image data supplied from the control unit 104, a manipulation icon, and the like.

The ROM 106 is a rewritable nonvolatile memory. The ROM 106 stores parameters and the like for use to cause the imaging device 100 to operate in addition to the operation program of the imaging device 100.

The RAM 107 is a rewritable volatile memory. The RAM 107 is for use as a storage area for temporarily storing data such as image data obtained by the operation of the imaging device 100.

The recording medium 108 is a memory card or the like that is detachably mounted on the imaging device 100. The recording medium 108 records processed image data and the like that is stored in the RAM 107 by the image processing unit 103 as recorded image data.

The input unit 109 includes a plurality of manipulation members for receiving user's manipulation. The user's manipulation includes, for example, user's manipulation of instructing the imaging device 100 to start and end still image photographing, and user's manipulation of selecting an icon displayed on the display unit 105. The input unit 109 supplies an input signal corresponding to user's manipulation to the control unit 104. A state of manipulation on each manipulation member is monitored by the control unit 104.

When recording image data on the recording medium 108, the metadata generation/analysis unit 110 generates various metadata such as an exchangeable image file format (Exif) standard to be attached to the image data on the basis of information at the time of photographing. In addition, when reading the image data recorded in the recording medium 108, the metadata generation/analysis unit 110 analyzes the metadata applied to the image data. The metadata includes, for example, setting information at the time of photographing, photographing time information, image data information, feature information of an object included in the image data, and the like. Furthermore, in a case where moving image data is recorded, the metadata generation/analysis unit 110 can generate metadata for each frame of the moving image and apply the metadata to the moving image data.

The hash value generation unit 111 executes a hash function on image data input by the control unit 104 to generate (calculate) a hash value. The generation of the hash value may be executed by the control unit 104 instead of the hash value generation unit 111. The hash value generation unit 111 may generate a hash value for the image data or may generate a hash value for the entire image file including the image data.

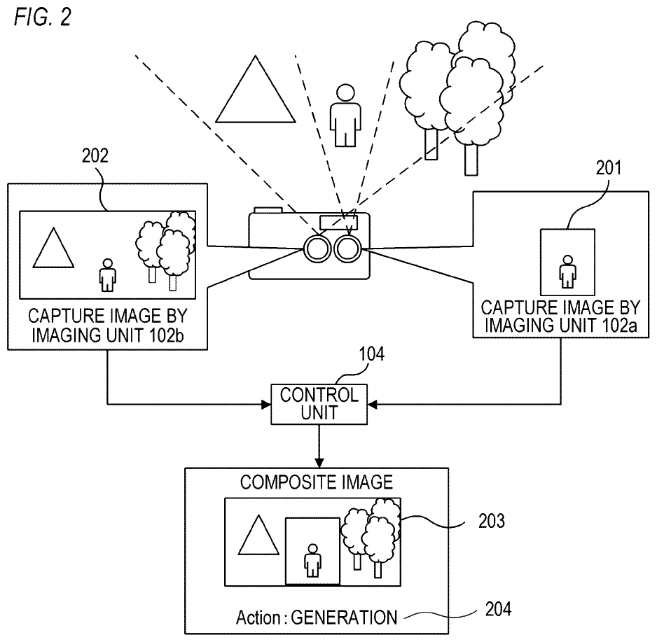

FIG. 2 is a diagram for explaining generation of a composite image. Two images 201 and 202 captured by the imaging unit 102a and the imaging unit 102b have different view angles. A view angle of the image 202 captured by the imaging unit 102b is wider than a view angle of the image 201 captured by the imaging unit 102a. Note that, although in the following description, an example of compositing two images having different view angles will be described, the number of images to be composited may be three or more. The present embodiment is applicable to a case where when a composite image is generated by compositing a plurality of images, in a case where according to a condition, it is desired to prove that the composite image is an original image that has not been edited.

The imaging unit 102a has a narrower view angle than the imaging unit 102b, and is the default imaging unit 102 of the imaging device 100. The user uses the default imaging unit 102a to determine a photographing range and image the object. In trimming editing after photographing, in order to enable trimming from an image having a view angle wider than that of the image 201 captured by the imaging unit 102a, the imaging device 100 performs imaging also by the imaging unit 102b at the same time as imaging by the imaging unit 102a. Since the image 202 captured by the imaging unit 102b has been captured at the same timing as the imaging unit 102a and its view angle is wider than that of the image 201, an object shown in the image 201 is also shown in the image 202. An imaging range of the image 202 includes an imaging range of the image 201.

The image processing unit 103 composites the images 201 and 202 simultaneously captured by the imaging unit 102a and the imaging unit 102b to generate a composite image 203. The image processing unit 103 can generate a composite image by compositing, around the image 201, areas of the image 202 excluding an area corresponding to the image of the image 201. The metadata generation/analysis unit 110 adds, to the generated composite image, history information indicating that the composite image has not been edited, i.e., the composite image is an original image. Specifically, the metadata generation/analysis unit 110 records “generation” in an item of Action included in Manifest based on the C2PA standard. Manifest is information for proving authenticity (hereinafter, it will be described as authenticity proof information).

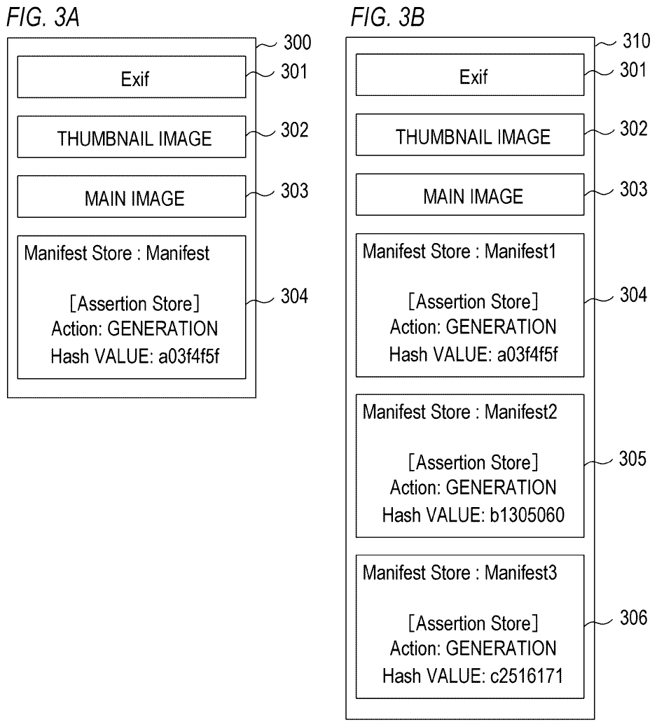

FIGS. 3A and 3B are diagrams illustrating an outline of recorded contents of an image file. An image file 300 in FIG. 3A includes areas where an Exif 301, a thumbnail image 302, a main image 303, and a Manifest Store 304 are recorded.

In the area of the Exif 301, metadata according to an Exif standard generated by the metadata generation/analysis unit 110 is recorded. The areas of the thumbnail image 302 and the main image 303 record the latest compressed image data. The area of the Manifest Store 304 records the authenticity proof information.

In a case where recording in the JPEG format is instructed by the user, the control unit 104 records, in the area of the main image 303, data of the main image generated in the JPEG format. The control unit 104 may record the data of the main image in a format other than the JPEG format.

The Manifest Store 304 includes an area of Assertion Store. The area of Assertion Store includes items of Action and Hash value. As the item of Action, for example, a character string of “generation” indicating that the image file 300 is a newly generated image (original image) or a character string of “editing” indicating that the image file is an edited image is recorded. In a case where the image file 300 is a newly generated image, a character string “generated with camera” including a device name that has generated the image file may be recorded as the item of Action. Information recorded in Action is history information indicating that the image has not been edited or history information indicating that the image has been edited. As the Hash value, a hash value of the image file 300 is recorded.

Although the image file 300 in FIG. 3A includes one Manifest Store 304, it may include a plurality of Manifest Stores. An image file 310 in FIG. 3B includes three Manifest Stores 304 to 306. For example, the first Manifest Store 304 and the second Manifest Store 305 are derived from history information respectively added to the two images developed by the imaging device 100. Furthermore, the third Manifest Store 306 is history information added to an image generated by compositing the two images after photographing. The latest history information of the image file 310 is the third Manifest Store 306.

The image file 310 including the plurality of Manifest Stores 304 to 306 may store management information of the Manifest Store before the Manifest Store 304. The management information includes information such as a link to each Manifest Store, the number of Manifest Stores, and which is the latest Manifest Store.

Furthermore, the image file 310 may record the Manifest Stores 304 to 306 from oldest to newest without having the management information, and make the Manifest Store 306 recorded last be the latest. In addition, the Manifest Stores 304 and 305 may each include information indicating that it has been added at the time of photographing. Note that the Manifest Stores 304 to 306 may each include a thumbnail image at the time when each is added to the image file 310.

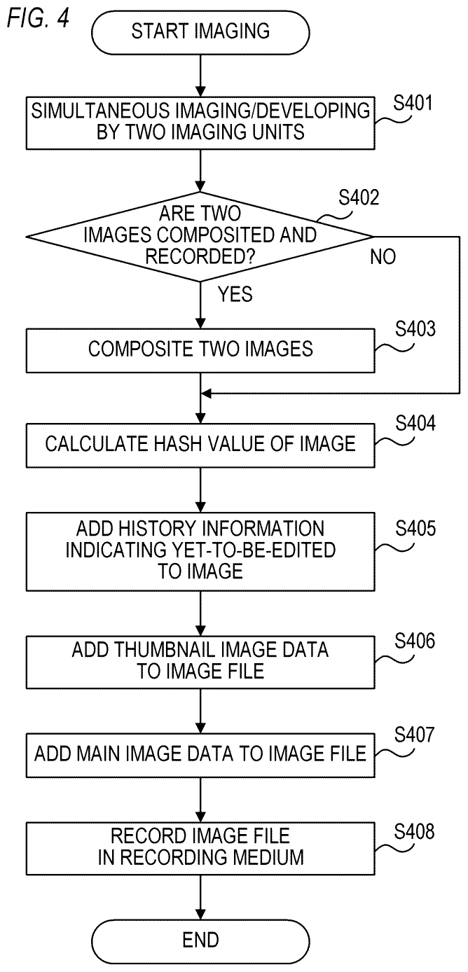

History information adding processing at the time of imaging will be described with reference to FIG. 4. FIG. 4 illustrates processing in which the imaging device 100 adds the history information to each of two images captured simultaneously and having different view angles or to a composite image obtained by compositing the two images. The imaging device 100 may add the authenticity proof information including the history information to each image.

In step S401, the control unit 104 drives each imaging unit 102 in response to imaging start manipulation by the user. Each imaging unit 102 simultaneously images an object. The image processing unit 103 develops the image captured by the imaging unit 102.

In step S402, the control unit 104 determines whether or not to composite the simultaneously captured images and then record the images. The user can preset or change whether the simultaneously captured images are composited and then recorded or individually recorded and then composited. In a case where the simultaneously captured images are composited and then recorded, the processing proceeds to step S403. In a case where the simultaneously captured images are individually recorded without being composited, the processing proceeds to step S404.

In a case where the simultaneously captured images are composited and then recorded, in the example of FIG. 2, the image 201 and the image 202 are not individually recorded but are composited and then recorded. Processing of steps S404 to S408 is executed on the recorded composite image 203.

In a case where the simultaneously captured images are individually recorded without being composited, in the example of FIG. 2, the processing of steps S404 to S408 is executed for each of the image 201 and the image 202. Note that the image processing unit 103 may execute the processing of steps S404 to S408 on a composite image obtained by compositing the image 201 and the image 202 after the images are individually recorded.

In step S403, the control unit 104 causes the image processing unit 103 to composite the two images simultaneously captured by the imaging unit 102. As described with reference to FIG. 2, the two images 201 and 202 to be composited are images obtained by imaging the same object at the same timing. A range of imaging by the imaging unit 102a is included in a range of imaging by the imaging unit 102b.

The composite image 203 is an image in which areas of the image 202 excluding an area corresponding to the image 201 are composited around the image 201. The composite image 203 can be generated, for example, by pasting the image 201 on the image 202 from above. A position where the image 201 is pasted on the image 202 is determined by detecting a range captured by the image 201 from the image 202.

In a case where a resolution of the image 201 is different from a resolution of the image 202, the image processing unit 103 may generate a composite image after matching the resolution of the image 201 with the resolution of the image 202 by upscaling or downscaling the image 201 or the image 202. Note that, in a case where the resolution of the image 201 and the resolution of the image 202 are the same, the image processing unit 103 may set the image 202 as the composite image generated in step S403 without compositing the image 201 and the image 202.

In step S404, the control unit 104 causes the hash value generation unit 111 to calculate a hash value of the composite image generated in step S403. In addition, in a case where the images captured by the respective imaging units 102 are individually recorded, the hash value generation unit 111 calculates hash values of the respective images. The control unit 104 holds the calculated hash values in the RAM 107.

In step S405, the control unit 104 causes the metadata generation/analysis unit 110 to generate the history information indicating that the composite image has not been edited, and adds the same to the composite image. Specifically, the metadata generation/analysis unit 110 records information indicating “generation” in the item of Action of Assertion Store in the Manifest Store 304. In this manner, the control unit 104 does not regard compositing as editing but regards the composite image as an image yet to be edited, and adds the history information indicating that the composite image has not been edited.

Furthermore, in a case where the images captured by the respective imaging units 102 are individually recorded, the metadata generation/analysis unit 110 generates the history information indicating that the images have not been edited and adds the history information to the respective images. Furthermore, the metadata generation/analysis unit 110 may give three pieces of history information to a composite image obtained by compositing the images captured by the respective imaging units 102 after the images are individually recorded, as illustrated in the image file 310 of FIG. 3B. The three pieces of history information are the Manifest Stores 304 and 305 corresponding to the two images before compositing and the Manifest Store 306 corresponding to the composite image.

In step S406, the control unit 104 causes the image processing unit 103 to give data of the thumbnail image to the image file of the composite image. Furthermore, in a case where the images captured by the respective imaging units 102 are individually recorded, the image processing unit 103 adds the thumbnail image data to the image files of the respective images.

In step S407, the control unit 104 causes the image processing unit 103 to give the main image data to the image file of the composite image. Furthermore, in a case where the images captured by the respective imaging units 102 are individually recorded, the image processing unit 103 adds the main image data to the image files of the respective images.

In step S408, the control unit 104 records, in the recording medium 108, the image file of the composite image on the RAM 107. Furthermore, in a case where the images captured by the respective imaging units 102 are individually recorded, the control unit 104 individually records the image files of the respective images in the recording medium 108.

In a case where the images captured by the respective imaging units 102 are individually recorded, an image with a wider view angle may be recorded in a storage area that is not referred to by the user. In the example of FIG. 2, the image 202 captured by the imaging unit 102b is recorded in, for example, a storage area that is not referred to by the user, such as a private folder for a system. The image 202 may be recorded in the same folder as the image 201 or in the image file of the image 201.

In a case where the image 201 and the image 202 are recorded separately, a file name of the image 201 and a file name of the image 202 may include the same character string so that it can be identified that the image 201 and the image 202 have been simultaneously captured. In addition, the image 201 and the image 202 may be associated with each other and recorded in a table or a database. In addition, metadata of the image 201 and metadata of the image 202 may include the same ID so that it can be identified that the image 201 and the image 202 have been simultaneously captured.

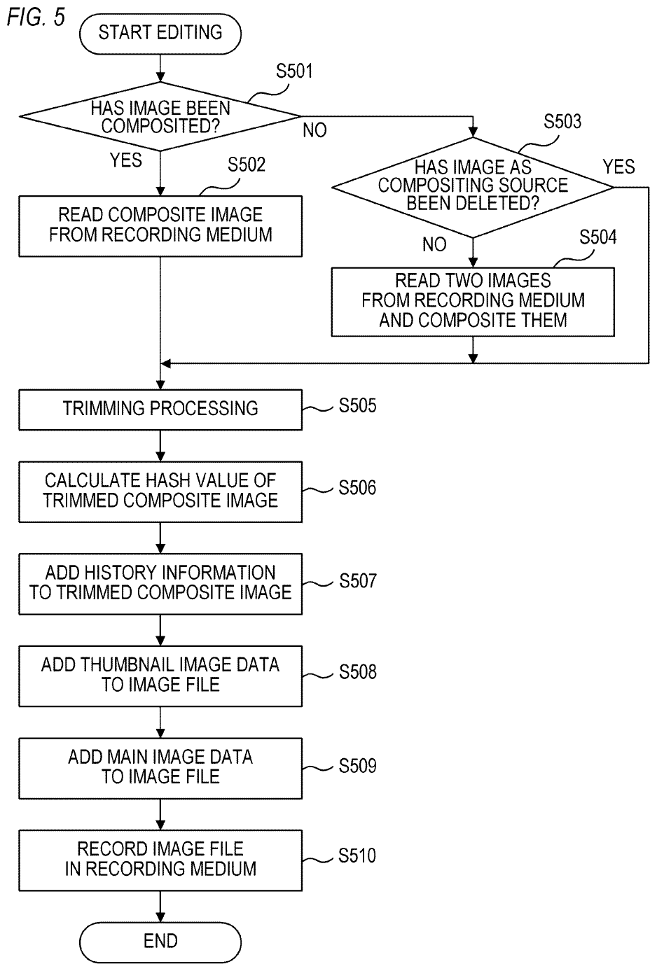

History information adding processing at the time of editing will be described with reference to FIG. 5. FIG. 5 illustrates processing of adding the history information when the composite image recorded in FIG. 4 is edited. In the example of FIG. 2, in a case where the composite image 203 is trimmed so as to have a view angle wider than that of the image 201, the control unit 104 adds history information indicating that the trimmed composite image has not been edited to the trimmed composite image. In this manner, the control unit 104 does not regard trimming as editing but regards the composite image after trimming as an image yet to be edited, and adds the history information indicating that the composite image has not been edited to the trimmed composite image.

By contrast, in a case where the composite image 203 is trimmed so as to have a view angle narrower than that of the image 201, the control unit 104 adds history information indicating that the trimmed composite image has been edited to the trimmed composite image. In this manner, the control unit 104 regards trimming as editing and regards the composite image after trimming as an edited image, and adds the history information indicating that the composite image has been edited to the trimmed composite image.

In step S501, the control unit 104 determines whether or not an image as a processing target that is recorded on the recording medium 108 has been composited. In a case where the image as a processing target has been composited, the processing proceeds to step S502. In a case where the image as a processing target is individually recorded without being composited, the processing proceeds to step S503.

For example, in a case where there is a file including the same character string as a file name of the image as a processing target, the control unit 104 can determine that the image as a processing target has not been composited with an image captured simultaneously. In addition, in a case where the image as a processing target is associated with an image to be paired (an image captured simultaneously with the image as a processing target) in the table or the database, the control unit 104 can determine that the image as a processing target has not been composited with the image captured simultaneously. Furthermore, in a case where there is an image having metadata including the same ID as an ID included in metadata of the image as a processing target, the control unit 104 can determine that the image as a processing target has not been composited with the image captured simultaneously.

In step S502, the control unit 104 reads the composite image as a processing target that is recorded in the recording medium 108 onto the RAM 107.

In step S503, the control unit 104 determines whether an image as a compositing source has not been deleted or not. In the example of FIG. 2, the control unit 104 determines whether, of the image 201 and the image 202, the image 202 has been deleted from the recording medium 108 or not. In a case where the image 202 can be acquired from the recording medium 108, the control unit 104 can determine that the image 202 has not been deleted from the recording medium 108. In a case where the image 202 has been deleted from the recording medium 108, the processing proceeds to step S505. In a case where the image 202 has not been deleted from the recording medium 108, the processing proceeds to step S504.

The image 202 may be deleted when it has not been composited with the image 201 for a predetermined period of time. This is because it is assumed that editing processing such as trimming is not executed in the future when the image 201 and the image 202 have not been composited even after the predetermined period elapses. The predetermined period can be, for example, one month. The user is not aware of the image 202 simultaneously captured in the background by the imaging unit 102b because the image is captured by the imaging unit 102a which is the default imaging unit 102. Therefore, in a case where compositing processing is not executed for the predetermined period, the image 202 is considered not to be used and is deleted.

In step S504, the control unit 104 reads the two images recorded in the recording medium 108 onto the RAM 107. The two images are images with different view angles simultaneously captured by the imaging unit 102a and the imaging unit 102b. The control unit 104 composites the two images read onto the RAM 107. A method of compositing the two images is the same as that in step S403.

In step S505, the control unit 104 executes trimming processing of the composite image by the image processing unit 103 according to manipulation by the user. While checking the composite image displayed on the display unit 105, the user designates an arbitrary range for the composite image and performs the trimming editing.

In step S506, the control unit 104 causes the hash value generation unit 111 to calculate a hash value of the trimmed composite image. The control unit 104 holds the calculated hash values in the RAM 107.

In step S507, the control unit 104 causes the metadata generation/analysis unit 110 to generate the history information indicating that the composite image has not been edited or the history information indicating that the composite image has been edited, and adds the history information to the trimmed composite image. Specifically, the metadata generation/analysis unit 110 records information indicating “generation” or “editing” in the item of Action of Assertion Store in the Manifest Store 304.

In the trimming processing of step S505, the trimming editing processing of the composite image is performed. When the trimmed composite image satisfies a predetermined condition, the metadata generation/analysis unit 110 generates the history information indicating that the composite image has not been edited, and adds the history information to the composite image. The predetermined condition is, for example, that the composite image 203 in FIG. 2 is trimmed so as to have a view angle wider than that of the image 201. As described above, the metadata generation/analysis unit 110 adds the history information indicating that the composite image has not been edited to the composite image including the entire image 201 and trimmed using a part of the image 202. Specifically, the metadata generation/analysis unit 110 records information indicating “generation” in the item of Action of Assertion Store in the Manifest Store 304.

On the other hand, when the trimmed composite image does not satisfy the predetermined condition, the metadata generation/analysis unit 110 generates the history information indicating that the composite image has been edited and adds the history information to the trimmed composite image. A case where the composite image after trimming does not satisfy the predetermined condition is, for example, a case where the composite image 203 in FIG. 2 is trimmed so as to have a view angle narrower than that of the image 201. As described above, the metadata generation/analysis unit 110 adds the history information indicating that the composite image has been edited to the trimmed composite image which includes a part of the image 201 and in which the image 202 is not used. Specifically, the metadata generation/analysis unit 110 records the information indicating “editing” in the item of Action of Assertion Store in the Manifest Store 304.

In step S508, the control unit 104 causes the image processing unit 103 to give the thumbnail image data to an image file of the trimmed composite image. In step S509, the control unit 104 causes the image processing unit 103 to give the main image data to the image file of the trimmed composite image. In step S510, the control unit 104 records, in the recording medium 108, the image file of the trimmed composite image on the RAM 107.

According to the above embodiment, the imaging device 100 adds, to a composite image obtained by compositing two images captured simultaneously and having different view angles, the history information indicating that the composite image has not been edited. Furthermore, in a case where the composite image has been trimmed so as to have a wider view angle than the image having a narrower view angle, the imaging device 100 adds the history information indicating that the trimmed composite image has not been edited to the trimmed composite image. As a result, the imaging device 100 can treat a composite image obtained by compositing a plurality of images captured at the same timing as an original image that has not been edited.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to provide an imaging device capable of treating a composite image obtained by compositing a plurality of simultaneously captured images as an image that has not been edited.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-051912, filed Mar. 26, 2025, which is hereby incorporated by reference herein in its entirety.

What is claimed is:

1. An imaging device comprising:
a processor; and
a memory storing a program which, when executed by the processor, causes the imaging device to:
execute imaging processing of capturing, simultaneously with a first image, a second image having a view angle wider than a view angle of the first image;
execute generation processing of generating a composite image in which areas of the second image excluding an area corresponding to the first image are composited around the first image; and
execute adding processing of adding, to the composite image, history information indicating that the composite image has not been edited.

2. The imaging device according to claim 1, wherein
in the adding processing, in a case where the composite image is trimmed so as to have a view angle wider than the view angle of the first image, history information indicating that the composite image has not been edited is added to a trimmed composite image.

3. The imaging device according to claim 1, wherein
the composite image is an image recorded after the first image and the second image are composited without being individually recorded.

4. The imaging device according to claim 1, wherein
the composite image is an image obtained by compositing the first image and the second image after the first image and the second image are individually recorded.

5. The imaging device according to claim 4, wherein
the second image is recorded in a storage area not referred to by a user, in a same folder as the first image, or in a file of the first image.

6. The imaging device according to claim 4, wherein
a file name of the first image and a file name of the second image include a same character string so as to identify that the first image and the second image have been simultaneously captured.

7. The imaging device according to claim 4, wherein
the first image and the second image are associated with each other and recorded in a table or a database.

8. The imaging device according to claim 4, wherein
metadata of the first image and metadata of the second image include a same ID so as to identify that the first image and the second image have been simultaneously captured.

9. The imaging device according to claim 4, wherein the second image is deleted in a case where the second image is not composited with the first image for a predetermined period.

10. The imaging device according to claim 1, wherein
in the generation processing, in a case where a resolution of the first image is different from a resolution of the second image, the composite image is generated after matching the resolution of the first image with the resolution of the second image by upscaling or downscaling the first image or the second image.

11. The imaging device according to claim 1, wherein
in the generation processing, in a case where a resolution of the first image and a resolution of the second image are the same, the second image is set as the composite image without compositing the first image and the second image.

12. The imaging device according to claim 1, wherein
in the adding processing, in a case where the composite image is trimmed so as to have a view angle narrower than the view angle of the first image, history information indicating that the composite image has been edited is added to a trimmed composite image.

13. A method for controlling an imaging device, comprising:
capturing, simultaneously with a first image, a second image having a view angle wider than a view angle of the first image;
generating a composite image in which areas of the second image excluding an area corresponding to the first image are composited around the first image; and
adding, to the composite image, history information indicating that the composite image has not been edited.

14. A non-transitory computer readable medium that stores a program, wherein the program causes a computer to execute a method for controlling an imaging device, the method comprising:
capturing, simultaneously with a first image, a second image having a view angle wider than a view angle of the first image;
generating a composite image in which areas of the second image excluding an area corresponding to the first image are composited around the first image; and
adding, to the composite image, history information indicating that the composite image has not been edited.
